(19) United States
(12) Patent Application Publication
(10) Pub. No.: US 2025/0086663 A2
(43) Pub. Date: Mar. 13, 2025

(54) GENERATING AUDIENCE LOOKALIKE MODELS

(71) Applicant: STACKADAPT INC., Toronto (CA)

(72) Inventors: Nedialko DIMITROV, Toronto (CA); Ruize LUO, Toronto (CA); Zeynep AKKALYONCU, Toronto (CA); Yahya RAFIYEV, Toronto (CA)

(73) Assignee: STACKADAPT INC., Toronto (CA)

(21) Appl. No.: 18/626,567

(22) Filed: Apr. 4, 2024

(51) Int. Cl. G06Q 30/0201

(52) U.S. Cl. CPC G06Q 30/0201

(57) ABSTRACT

Systems and methods described herein may determine audiences for content delivery. A server receives configuration inputs for identifying a target audience from a content-generating user. The configuration inputs indicate the target audience, baseline audience, and special audience. The target audience includes targeted end-users for the content. The baseline audience includes a broad population of end-users having a population characteristic (e.g., geography). The special audience includes a selected population of end-users having a special characteristic in the topics previously accessed by the end-users, such that the server correlates the baseline audience with the special audience to identify the target audience of target users who accessed a webpage having the topic and who are located in, e.g., a geography. The server uses topics terms from all target users to generate a ranked-list of context terms the content-user applies to predict whether webpages have the target audience.

### CROSS-REFERENCE TO RELATED APPLICATIONS

This application claims the benefit of U.S. Provisional Application No. 63/501,455, filed May 11, 2023, which is incorporated by reference in its entirety.

### TECHNICAL FIELD

This application relates generally to systems and methods for defining audiences for content selection. More specifically, it relates to allowing content providers to efficiently identify audiences with contextual relevant interests for particular types of content.

### BACKGROUND

Conventional systems allow for connecting content from content campaigns with content distributors based on a set of keywords using keyword targeting. For example, a search engine may sell ads to appear when search requests contain specified keywords. This basic method provides a relatively poor experience in which content to be distributed is often irrelevant to the search. For example, a content generator wanting to distribute information related to apple pies and bakeries may want to search for and publish their content on websites based on the keyword “apple,” yet the content could be inadvertently placed on technology or business websites discussing the tech company of the same name, Apple®, because such sites will also contain the “apple” keyword.

A second method for placing advertisements may include behavioral targeting. Under this method, a content generator (e.g., advertiser) can specify the retargeting of online advertisements to users that have been identified as having performed a conversion. Users with similar conversion characteristics (e.g., purchasing an item in the prior three months) may be grouped together. The users in the group may then be matched with a particular online content for delivery. However, with this method, the content generators are limited to selecting from only those predefined groups, and there are competing incentives between content generators and content publishers/providers, such that content publishers/providers may want to place content, articles, or other material in as many or as few groups as possible, which can overly-limit or oversaturate the delivery of the collocated content belonging to the content generator. In addition, because there are only a limited number of groupings, the content delivered to the users may be of limited relevance.

A content selection service (e.g., placement bidding service) may distribute and deliver content on behalf content creator in accordance with a content campaign in accordance with keyword targeting. Under one approach, upon detecting entry of certain terms in a search engine from a user, the service may provide content (e.g., online advertisements) to the user based on the terms. While this approach can deliver targeted content relevant to the user, the approach may rely on the user expressly entering particular keywords into the search engine. Due to the reliance on the particular search terms, this approach for keyword targeting for content delivery may be difficult to apply in circumstances where the user does not or cannot enter in terms.

Another problem is that many user devices tend to strip information about the users for privacy purposes, limiting the details about the users available for identifying ways to categorize and target the users.

### SUMMARY

What is needed is a means for constructing contextually relevant audiences for keyword-targeted online content distribution, without reliance on detailed information gathered from user devices about the individual users, or reliance on a search engine environment. The systems and methods disclosed herein are intended to address certain shortcomings, but embodiments may also provide additional or alternative benefits as well. Disclosed herein are systems and methods that address the above-discussed shortcomings in the art and may also provide any number of additional or alternative benefits as well.

In an embodiment, a computer-implemented method for determining audiences of contextually relevant content distribution may comprise receiving, by a computer, one or more configuration inputs via a user interface of a content-user, the one or more configuration inputs indicating a target audience and one or more context terms; identifying, by the computer, a set of target users associated with the one or more context terms defining the target audience, by cross-referencing a first plurality of end-users of a special audience against a second plurality of end-users of a background audience; identifying, by the computer, a ranked-order list of context terms associated with each target end-user of the target audience; and training, by the computer, a classifier to predict a probability of a lookalike audience for a webpage by applying the classifier on the ranked-order list of context terms associated with the target audience. In some implementations, the method further includes extracting, by the computer, using a corpus of millions of documents, sets of context terms that designate topics that appear in the corpus and rank highly in the list. In this way, the computer transforms the rank order list of context terms into descriptive contexts associated with the target audience.

In another embodiment, a system for determining audiences of contextually relevant content distribution may comprise a computer having at least one processor, configured to: receive one or more configuration inputs via a user interface of a content-user, the one or more configuration inputs indicating a target audience and one or more context terms; identify a set of target users associated with the one or more context terms defining the target audience, by cross-referencing a first plurality of end-users of a special audience against a second plurality of end-users of a background audience; identify a ranked-order list of context terms associated with each target end-user of the target audience; and train a classifier to predict a probability of a lookalike audience for a webpage by applying the classifier on the ranked-order list of context terms associated with the target audience.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 depicts a block diagram of a distributed computer system for determination of audiences for content delivery, according to an embodiment.

FIG. 2 depicts a flow chart of a method for configuring a target audience of targeted end-users that define a lookalike audience for content delivery, according to an embodiment.

FIGS. 3A-3E show user interfaces for configuring a contextual content campaign directed to a particular target audience by a content-user, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments described herein include a system of one or more computing devices that receive a stream of content objects from a plurality of data sources. A content stream associated with the content objects includes a stream of data pairs, which a server of the system extracts, recognizes, and organizes as the pairs of various data types. In some cases, the content stream expressly indicates the pairs to the server. Additionally or alternatively, the server includes programming that automatically identifies and extracts the pairs for each content object received with the content stream. The server identifies various types of data for deriving the data-pairs, and derives the data-pairs, in accordance with pre-configurations of the software programming. The server then extracts the data-pairs of the content stream, according to the pre-configurations or the express indication of the content stream. Non-limiting examples of data-pairs of the content stream include: [user identifier, content]; [anonymized identifier, content]; and [HashedIPAddress, URL]; among others. The server may generate, determine, or otherwise identify one or more associations between, for example, end-user devices, content, topics, or words of webpages. The association may indicate, for example, instances that the end-user device accessed the webpage. The server may identify a device identifier for the end-user device that accessed one or more webpages. In some cases, the server (or related database) may capture these devices identifiers and track the end-user devices that accessed the webpages using the device identifiers and/or using a cookie installed and invoked on the end-user devices. Non-limiting examples of the identifier(s) may include a network address associated with the end-user's device, such as an Internet Protocol (IP) address, a hashed IP address, or a media access control (MAC) address, a unique user identifier, a unique device identifier (sometimes referred to as a “UDID,” “device unique identifier,” “DUID,” or the like), an account identifier, or an identifier for advertiser (IDFA), among others. In some cases, the identifier includes an anonymized identifier, which may be algorithmically derived using one or more identifiers, thereby obfuscating and anonymizing the underlying identifiers; or the anonymized identifier may be an arbitrarily generated value (e.g., randomly generated value, quasi-random value).

The server extracts or identifies one or more topic words using the content objects, data-pairs, or other types of data or server-executed operations. Topic words include a set of potentially time-dynamic key phrases (of one or more words) that indicate a topic in a content object. As the content of the Internet changes and events (and thus topics) may be fluid, the time-dynamic nature of the key phrases beneficially helps to keep the context-targeting relevant to appropriate timeframes of the topics and content objects. Non-limiting examples of topics in a content object, as indicated by the topic words, may include “Thor,” “banana,” or “UN General Assembly.”

The computing system may collect and process online content to derive information about the online content object and the end-user who access the online content, which includes processing each content object into a set of one or more topic words. A server of the system collects or extracts the content objects from the content stream, and processes each content object to extract the set of one or more topics identified in the particular content object. The server may store the topics for each piece of content into a database, such as a topic database.

The computing system may associate end-users with particular topics. For instance, the server may estimate the relative relevance of the end-users to one or more topics. A server references a content stream and a topic database containing the topics extracted from content objects. The server identifies the content objects accessed by the end-users and associates each end-user with the topics identified in the content objects accessed by the particular end-user. As an example, the content stream includes two users, user 1 (User1) and user 2 (User2), and two content objects, content object A (ContentA) and content object B (ContentB), where the server identifies the sequence of: user 1 accessing content object A {User1, ContentA}; user 2 accessing content object A {User2, ContentA}; and user 1 accessing content object B {User1, ContentB}. At the end of the sequence, the server associates user 1 with the set of topics extracted for content object A and content object B, and further associates user 2 with the set of topics extracted for content object A.

The computing system may receive or derive a set of phrases relevant to the topics associated with content-generation users (sometimes referred to as “content users”), including in-context phrases and out-of-context phrases. In some cases, the content user expressly indicates the in-context phrases and/or the out-of-context phrases. Additionally, or alternatively, the system computes relevant phrases automatically. The server receives user input indicating phrases for identifying topics of interest for the content user, which the content enters via a graphical user interface. The server takes the phrases entered by the user input, and computes additional relevant phrases using, for example, probabilistic implications between words, geometric means, and a large corpus of processed documents or other types of data files. In the background, the server computes scores for each topic word, which allows the server to rank particular pieces of content in the content objects and/or particular end-users based on how much the content object or the end-user fits into the content-user's specified topic.

In some embodiments, the computing system includes hardware and software for a content summary-generation subsystem (sometimes referred to as a “summary generator”), which includes software programming that generates a content summary for a given content object. After scoring the content objects and/or end-users, the server identifies the most-highly scoring pieces of content and sends the content objects containing those pieces of content to the summary generator to generate corresponding summaries. The server sends the content summaries to a client device of the content-user for display to the content-user via the graphical user interface.

The summary generator takes pieces of content as input and generates short-sentence summaries of that piece of content for display at the graphical user interface. Unlike conventional summarizing software, the summary generator may generate summaries containing specific relevant phrases associated back to the phrase's context within one or more content objects related to a particular topic. In this way, when the content-user clicks on the specific relevant phrase in the summary, the content-user can see how that particular relevant phrase appears in the original online content objects related to the topic.

The summary generator does this by ranking each content object according to how highly the content objects scored in the topic. The summary generator identifies the highest-scoring content object having a particular relevant phrase. The summary generator then selects only the pieces of the content around that phrase, and feeds only those pieces of content around the phrase to artificial intelligence (AI) functionality of a machine-learning architecture of the content generator (sometimes referred to as a “content summary AI”) that applies various language processing models, such as Bidirectional Encoder Representations from Transformers (BERT), Generative Pretrained Transformer (GPT), and Large Language Model Meta AI (LLaMA), among others. The content generator applies one or more filters on the outputs of the content summary AI, such that the text of the outputs is significantly different (according to a threshold amount of distinction) from the text of the summarized content, and such that the outputs of the content summary AI contain the relevant phrase for display to the content-user.

In some embodiments, the computing system may generate an audience of interest for a content-user. The server receives a particular topic via the graphical user interface, and ranks the end-users in a database according to how much each end-user is interested in the final topic, as indicated by each end-users' past behavior. The server identifies the most interested end-users in that final topic and generates an audience of final topic containing the most interested end-user. The server stores the audience of end-users into the database (or “user database”), along with information about the end-users, such the topic scores of each end-user.

The computing system includes features and functions allowing the content-user to direct content (e.g., articles, videos, advertisements) to the end-users of the audience. In this way, the content-user employed the features and functions of the computing system to create an audience that the content-user knows is interested in the specific topic, as specified by the content-user via the graphical user interface.

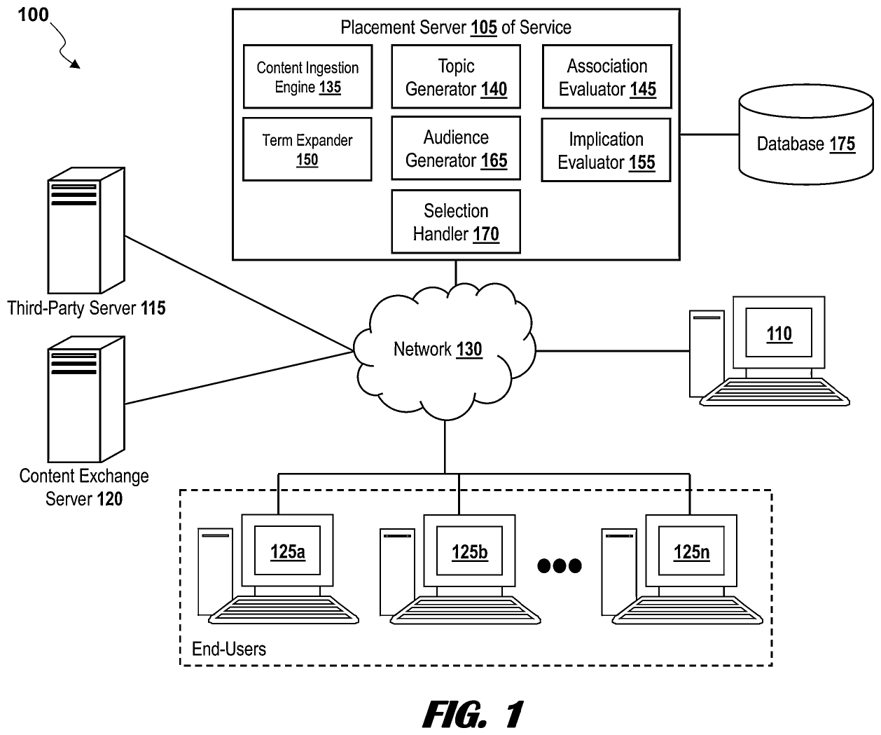

FIG. 1 depicts a block diagram of a distributed computer system 100 for determination of audiences for content delivery, according to an embodiment. The system 100 includes one or more placement servers 105 of a placement service, content provider devices 110 (sometimes herein referred to as client device) associated with a content provider preparing a content delivery campaign, third-party servers 115, content exchange servers 120 (sometimes referred to herein as “real-time bidding servers” or “RTB servers”), and end-user devices 125a-125n (collectively referred to as “end-user devices 125”), among others. The end-user devices 125 communicatively coupled with one another via one or more networks 130.

The placement server 105 includes software programming that defines or otherwise functions as a content ingestion engine 135, a topic generator 140, an association evaluator 145, a term expander 150, an implication evaluator 155, an audience generator 165, and a selection handler 170. The placement server 105 includes, or is in communication with, one or more databases 175. Each of the components in the system 100 may execute various software programming on one or more hardware processors coupled with memory to execute various operations. Certain components of the system 100 may be embodied in a single computing device or multiple computing devices.

The network(s) 130 includes any number of private or public networks for hosting and conducting electronic communications between electronic devices of the system 100. The network 130 may include telecommunications networks or data communications networks comprising hardware or software components for exchanging data between the devices of the system 100 in accordance with any number of telephony or networked communications.

The computing devices of the system 100 (e.g., servers, end-user devices 125, content provider devices 110) may include one or more computing devices and any type of computing device comprising hardware and software components configured to perform the various processes and tasks described herein, including one or more processors or software comprising machine-executable instructions executed by the one or more processors. Non-limiting examples of such computing devices of the system 100 include server computers, laptop computers, desktop computers, tablet computers, and smartphone mobile devices, among others. One or more servers (or other devices of the system 100), such as the placement server 105, execute webserver software for hosting one or more webpages according to web-related or data-communications protocols and computing languages.

The content ingestion engine 135 includes software programming for collecting and processing online content. The content ingestion engine 135 gathers content objects from a content stream, and processes the content objects based upon the content of the particular content object. For instance, the content ingestion engine 135 may tag or otherwise assign one or more topics to the particular content object. The content ingestion engine 135 stores the assigned topics for each content object in a database 175. In some cases, in processing, the content ingestion engine 135 may essentially parse or extract the content of the content object to identify, generate, or output a set of topic words.

In some embodiments, the content ingestion engine 135 includes software programming for a webpage indexer, web crawler, and/or web scraper executing on the placement server 105. In such embodiments, the content ingestion engine 135 may gather, aggregate, or retrieve webpages hosted by webserver software executed on the third-party servers 115. Each webpage is an online document in a markup language (e.g., Hypertext Markup Language (HTML), Extensible Markup Language (XML)) stored or hosted by webserver software and database of the third-party server 115 and to be displayed on the end-user devices 125. The content ingestion engine 135 may extract and download various types of data associated with each webpage, which may include metadata or header information from the webpage coding or data packet traffic. The data associated with the webpages may include, for example, metadata, fingerprints, tags, scripts, images, text, and other content thereon. In some cases, the content ingestion engine 135 may retrieve or identify a page identifier (e.g., URL, web address, URI) corresponding to the webpage. Upon identification, the content ingestion engine 135 may store and maintain the data extracted from the webpage or the data traffic into the database 175.

The content ingestion engine 135 executing on the placement server 105 may gather, aggregate, or retrieve webpages hosted by webserver software executed on the third-party servers 115. Each webpage is an online document in a markup language (e.g., HTML, XML) stored or hosted by webserver software and database of the third-party server 115 and to be displayed on the end-user devices 125. In retrieving, the content ingestion engine 135 may extract and download various types of data associated with each webpage. The data extracted from the webpages may include, for example, metadata, fingerprints, tags, scripts, images, text, and other content thereon. In addition, the content ingestion engine 135 may retrieve or identify a page identifier (e.g., Uniform Resource Locator (URL), web address) corresponding to the webpage. Upon identification, the content ingestion engine 135 may store and maintain the data extracted from the webpage onto the database 175. The content ingestion engine 135 may also store and maintain an association among the data and the page identifier for the webpage onto the database 175.

The topic generator 140 executing on the placement server 105 may extract, identify, or otherwise determine a set of topic terms from the webpages of the third-party servers 115. Each topic may define or identify a semantic meaning or subject of the content in the webpage. For example, for a webpage with content containing a high number of words related to bicycles, the set of topic terms may include “bicycle,” “pedals,” “handlebars,” “race,” “commute,” “mountains,” “outdoors,” and “triathlon.” In some embodiments, the topic generator 140 may apply a machine-learning architecture on the webpages to determine the set of topic terms for each webpage. The machine-learning architecture may include, for example, a natural language processing algorithm, an information retrieval model, a topic model, tokenization model, and a latent semantic analysis, among others. The topic generator 140 may traverse through the data extracted from the webpages indexed on the database 175. For the data from each indexed webpage, the topic generator 140 may determine the set of topic terms for each webpage from the machine-learning architecture. With the determination, the topic generator 140 may store and maintain an association between the set of topic terms and the page identifier for the webpage onto the database 175.

The association evaluator 145 executing on the placement server 105 may generate, determine, or otherwise identify an association between each end-user device 125 and the content, topics, or words of webpages. The association may identify instances that the end-user device 125 accessed the webpage. In generating, the association evaluator 145 may identify a device identifier for the end-user device 125 that accessed the webpages indexed on the database 175. For example, the content ingestion engine 135 may keep track of the end-user devices 125 that accessed the webpages using a cookie on the end-user devices 125. The identifier may be a network address, such as an Internet Protocol (IP) address or a media access control (MAC) address, or a unique user identifier, such as a device identifier, an account identifier, or an identifier for advertiser (IDFA), among others. The association evaluator 145 may store and maintain an association between the data or the page identifier for the webpage, along with the device identifiers for the end-user devices 125 that accessed the webpage onto the database 175.

The association evaluator 145 configured to function as a computing system for associating users with topics. This audience server references the database containing records containing object-related data received from the content server and the content stream to associate each user with a set one or more topics the accessed or otherwise engaged with by the particular user. The audience server and/or the content server may extract or otherwise identify users and content topics accessed by the users. For example, two users, user 1 (User1) and user 2 (User2), access two content objects, content object A (ContentA) and content object B (ContentB) across three access instances. In this example, the content sequence indicates: user 1 accessed content object A {User1, ContentA}; user2 accessed content object A {User2, ContentA}; and user 1 accessed content object B {User1, ContentB}. At the end of that sequence, the audience server would associate user 1 with one or more topics of content object A and one or more topics of content object B; and also associate user 2 with one or more topics of content object A.

In addition, the association evaluator 145 may generate, determine, or otherwise identify an association between each particular end-user device 125 or user and one or more of the topic terms extracted from the webpages. The association evaluator 145 identifies the topic term derived from the webpage indexed on the database 175. For each webpage, the association evaluator 145 may also identify the each-user device 125 that accessed the webpage. Through each webpage, the association evaluator 145 may determine the association between the particular end-user device 125, the webpage, and the topic terms derived from the webpage. Based on the determination, the association evaluator 145 may store and maintain the association between the topic terms and each end-user device 125 onto the database 175.

In conjunction, the content provider device 110 may communicate and interface with the placement server 105 to define a new content delivery campaign or update a previously defined delivery campaign, including defining the audience of end-users targeted for the content delivery campaign. The content provider device 110 may detect, identify, or otherwise receive a set of inputs from a user to define the user's content delivery campaign. Using the content provider device 110, the user accesses an audience (or campaign) configuration webpage hosted by the placement server 105. As an example, the audience configuration webpage includes graphical user interface allowing the content-user to enter inputs configuring and defining the content-user's content delivery campaign.

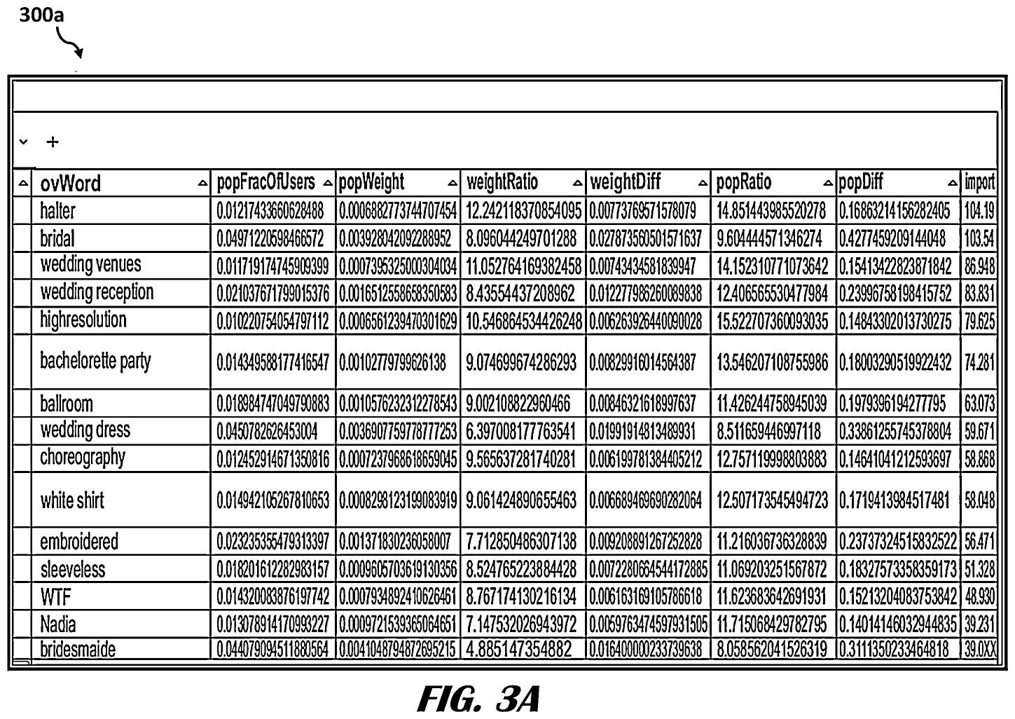

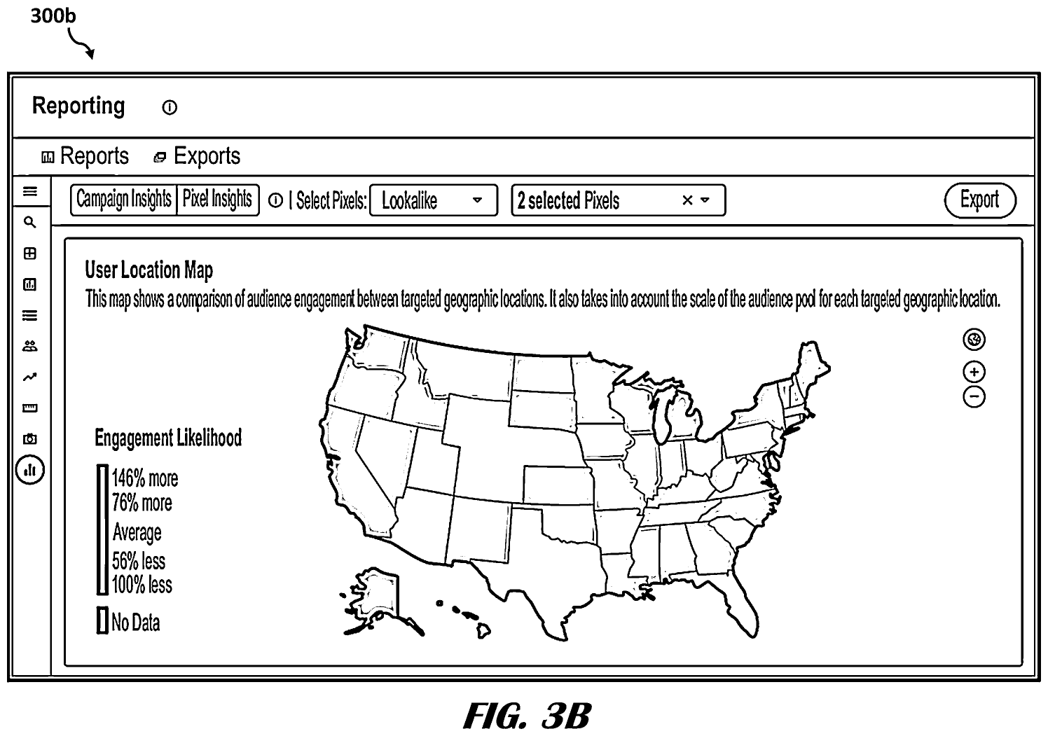

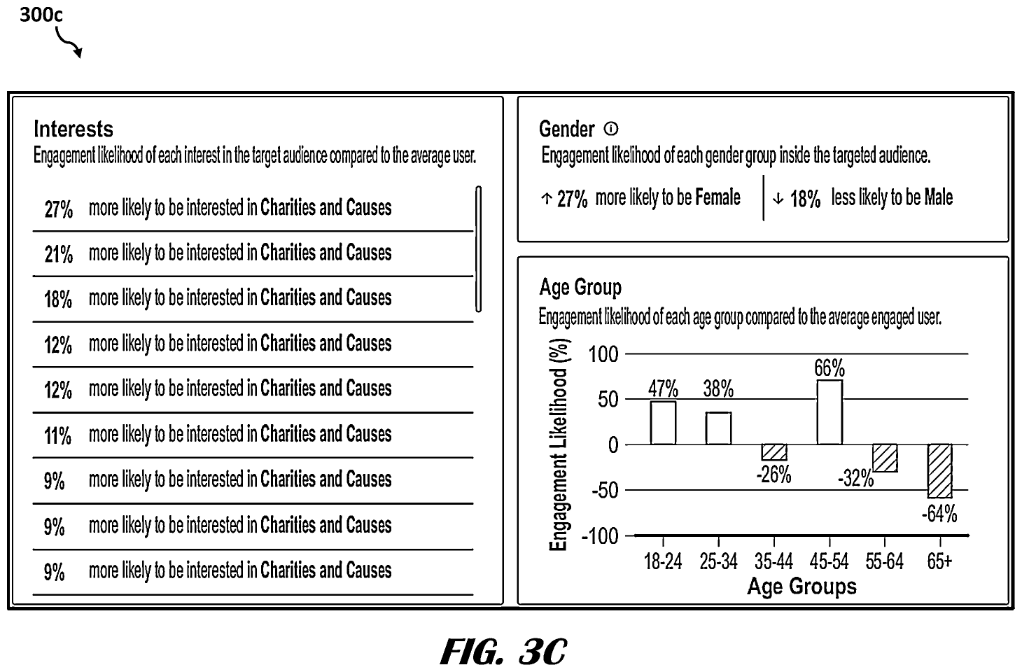

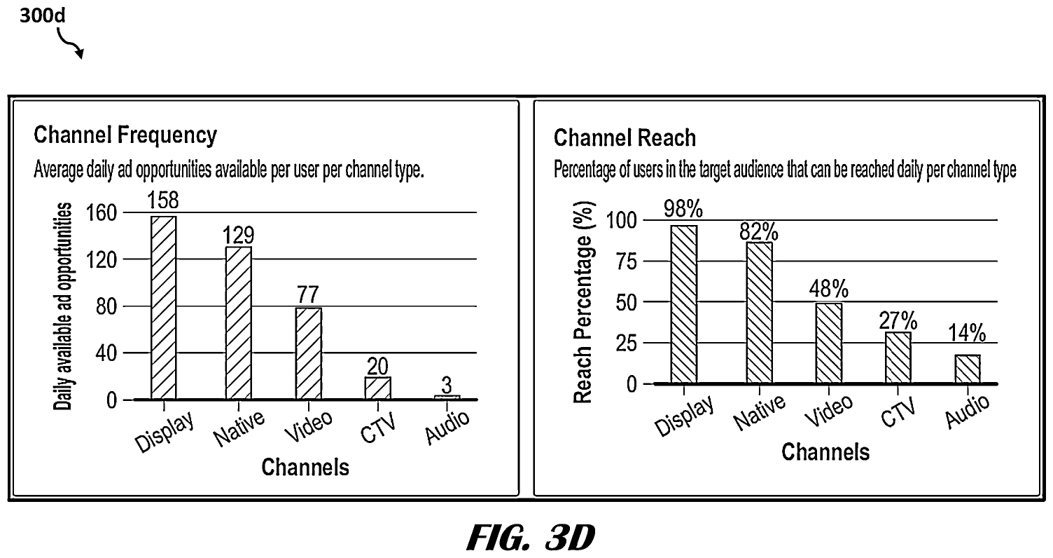

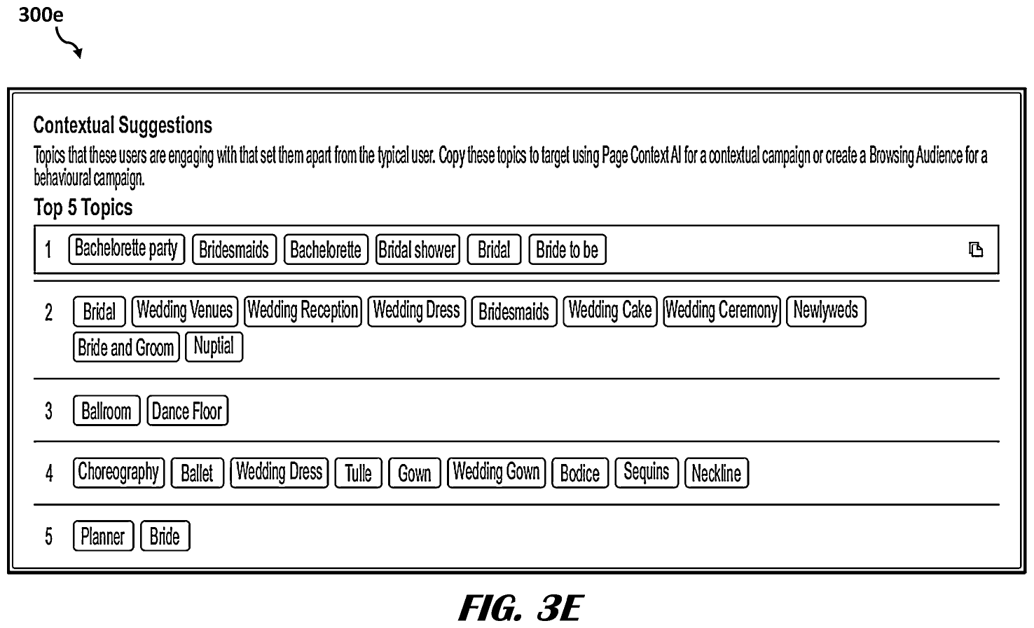

Examples of the audience configuration webpage (or similar graphical user interface) are show in FIGS. 3A-3E. The configuration inputs for defining the campaign and/or audiences may indicate, for example, a target audience, a background audience (sometimes referred to herein as a “baseline audience”) defined by a background characteristic of population end-users, a special audience defined by one or more targeted characteristics.

Optionally, in some embodiments, the configuration inputs may indicate, for example, a set of in-context terms or phrases and a set of out-of-context terms or phrases (collectively referred to as context terms), indicating the terms or phrases that are in context or out of context with respect to the target audience of the content delivery campaign. The in-context terms indicate the words or phrases from which additional contextual terms are to be found or identified. The out-of-context terms may identify or include words or phrases used to filter or remove one or more of the additional contextual terms found using the in-context terms. For example, the in-context terms include “Thor” and the out-of-context term include “Marvel®” to find additional terms related to Norse mythology, while avoiding references to comic characters. The content provider device 110 sends the set of inputs including the in-context terms and out-of-context terms to the placement server 105. Notably, the in-context terms and out-of-context terms are optional when extracting lookalike audience contextual topics.

The term expander 150 executing on the placement server 105 may initialize, train, or establish at least one machine-learning architecture to generate the additional context terms (sometimes referred to herein as beacon terms), using a corpus of documents (e.g., webpages, electronic documents) stored in an external or internal database (e.g., database 175). In general, the machine-learning architecture receives a set of inputs corresponding to the in-context and out-of-context terms, and outputs the set of additional context terms and a set of word implications (or weights) relating the inputs to the outputs. The machine-learning architecture includes any processor-executed machine-learning techniques and algorithms, such as various types of neural networks (e.g., convolutional neural networks (CNNs), deep neural networks (DNNs)), linear regression, logistic regression, k-means, k-nearest neighbors (kNN), or support vector machines (SVMs), among others.

The database 175 may store the corpus, which may include a set of documents (e.g., webpages, articles, or other pieces of content) containing any number of potential topics, terms, or phrases. In some cases, the set of documents used to train the machine-learning architecture may differ from the webpages indexed on the database 175. In some embodiments, the term expander 150 may also use additional natural language processing and vectorization machine-learning algorithms trained on the corpus maintained on the database 175.

Using the corpus, the term expander 150 trains the machine-learning architecture to calculate and determine various statistical associations among the terms, phrases, and other latent information in the corpus. The statistical associations (sometimes herein referred to as relationships) may include or identify: a probability of co-occurrence between any pair of terms or phrases among the set of documents in the corpus, a conditional likelihood (e.g., an n-gram), and a distance between the pair of terms and phrases within the set of documents, or any combination thereof, among others. To train, the term expander 150 may apply terms and phrases from the set of documents to the machine-learning architecture. By feeding the terms and phrases, the term expander 150 may process the terms and phrases using the set of weights in the machine-learning architecture to generate the additional context terms. The term expander 150 may calculate an error or loss metrics for the additional context terms by comparing to the measure derived from the set of terms in the corpus. The term expander 150 may iteratively set, adjust, or update the set of weights in the machine-learning architecture based on the loss metrics, until the machine-learning architecture reaches convergence. By adjusting the set of weights, the term expander 150 may update the machine-learning architecture to produce additional context terms reflecting the statistical association among the terms in the set of documents of the corpus on the database 175.

The term expander 150 may use the set of in-context-terms and the set of out-of-context terms received from the content provider device 110 to generate, determine, or identify additional context terms. In some embodiments, the term expander 150 may apply the machine-learning architecture to the in-context terms and out-of-context terms. In applying, the term expander 150 may feed the in-context terms and out-of-context terms as input into the machine-learning architecture. The term expander 150 may then process the input terms in accordance with the set of weights in the machine-learning architecture to generate the additional context terms. In processing, the term expander 150 may select a set of terms from the corpus having a statistical association with the in-context terms. The statistical association may satisfy a threshold amount (e.g., threshold co-occurrence) for inclusion. From the initial subset, the term expander 150 may filter, weigh less, or otherwise remove a subset of terms having a statistical association that satisfies a threshold amount (e.g., threshold co-occurrence) for removal, and may use the remaining set of terms as the additional context terms. With the generation, the term expander 150 may include the additional terms as part of the set of in-context terms to use in the audience definition.

The implication evaluator 155 executing on the placement server 105 may generate, determine, or otherwise calculate an implication score for each topic term determined from the webpages. The implication score may be based on a statistical association (e.g., co-occurrence, conditional probability, and distance) between, for example, topic terms in content accessed by end-users; or the topic terms and one or more of the set of in-context terms including the additional context terms on the webpages from which the topic term is generated, among other statistical associations. In some embodiments, the implication score for the topic term may be based on a number of occurrences of at least one of the context terms in the webpages, on which the topic term occurs. For each topic term, the implication evaluator 155 may identify the set of webpages indexed on the database 175 from which the topic term is derived. On each identified webpage, the implication evaluator 155 may determine or identify the number of occurrences of the context terms. Using the number of occurrences, the implication evaluator 155 may determine the implication score for the topic term.

Based on the implication scores for the set of topic terms, the implication evaluator 155 may identify or select one or more of the topic terms. The selection of topic terms may be used to define the audience for the content delivery campaign. In general, the higher the implication score, the more relevant the topic term may be to the context terms generated from the in-context and out-of-context terms. Conversely, the lower the implication score, the less relevant the topic term may be to the context terms generated from the in-context and out-of-context terms. In some embodiments, the implication evaluator 155 may rank the set of topic terms by the corresponding implication scores. From the ranking, the implication evaluator 155 may select N topic terms with the highest implication scores. In some embodiments, the implication evaluator 155 may compare the implication scores for the set of topic terms against a threshold score. The threshold score may define a value for the implication score at which to select the associated topic term. When the implication score for the topic term satisfies the threshold score, the implication evaluator 155 may select the topic term. Otherwise, when the implication score for the topic term does not satisfy the threshold score, the implication evaluator 155 may exclude the topic term. With the selection, the implication evaluator 155 may provide, send, or transmit the set of topic terms to the content provider device 110.

The content provider device 110 may present or display various sets of topic terms on the graphical user interface, operated by content-user to define the contextual content campaign. The topic terms and/or particular characteristics of end-users may be used to define the target audience for the content delivery campaign, the background audience, and/or the special audience of end-users for comparison against the background audience. The content provider device 110 may detect, identify, or receive a selection of the topic terms via the graphical user interface for defining the content delivery campaign. Additionally, the content provider device 110 of the content-user may retrieve, identify, or otherwise receive one or more sets of topic terms from the placement server 105. The sets of topic terms include a preconfigured set of topic terms identified based upon the relationships in among terms in the corpus. Moreover, the sets of topic terms include the sets of context terms generated or derived according to the configurations of the content-user, such as a set of ranked-order context topics for a target audience.

For instance, the audience generator 165 executing on the placement server 105 may generate, identify, or determine the target end-users and the topic terms for a target audience for the contextual content campaign. The content-user operates the content provider device 110 to enter and submit configuration inputs for the audience generator 165 to configure the target audience (e.g., end-users that accessed information about or interested in hockey) according to, for example, the indicated user characteristics of the baseline audience (e.g., geography) and the characteristics of the special audience (e.g., end-users that accessed content having topic terms related to hockey). The audience generator 165 extracts data records for the end-users of the target audience by correlating the end-users of the baseline audience against the end-users of the special audience. The placement server 105 applies the predefined list of topics on the user data records of the target audience to extract a contextually relevant, ranked-order list of context topics. For each identified target end-user, the placement server 105 computes relational scores between the end-user and each context topic. The data records for the particular target end-user indicate the topics identified in prior content accessed by the target end-user, stored in the user data records of the database 175. After the placement server 105 generates the scores for each topic term, the placement server 105 ranks the topic terms to generate the ranked-order list of context topics for the target audience, which the placement server 105 stores into the database 175 as a lookalike context, defined in part by the context topics.

In some embodiments, the audience generator 165 may use the topic terms selected via the content provider device 110 to determine the audience. In some embodiments, the audience generator 165 may use the set of topic terms as selected by the implication evaluator 155, without additional input from the content provider device 110. For each selected topic term, the audience generator 165 may access the database 175 to retrieve, fetch, or identify the associations between the topic term and the identifier for the end-user device 125. In some embodiments, the audience generator 165 may identify or select a subset of the identified end-user devices 125 for the audience for the topic term. The audience generator 165 may access the database 175 to identify the webpages associated with the topic term. For each end-user device 125, the audience generator 165 may determine a topic score based on number of times that the end-user device 125 accessed the webpages associated with the topic term. The audience generator 165, for example, receives cookie or pixel (tracking) data that reports or tracks information about the end-user devices 125 accessing the webpage or document. In some embodiments, the audience generator 165 may rank the identifier of the end-user or end-user devices 125 by the topic score.

The content provider device 110 may in turn retrieve, identify, or receive the audience definition from the placement server 105. The content provider device 110 may present or display information regarding the audience definition on the graphical user interface for defining the content delivery campaign. For example, the content provider device 110 may present the number of end-user devices 125 in the target audience (or lookalike audience), topic scores, device types, and locations, among other types of information. The content provider device 110 may detect, identify, or receive one or more inputs to adjust the audience definition (e.g., adjust the characteristics of the background audience; adjust the characteristics of the special audience), and may transmit the adjustments to the placement server 105 to update the context terms of the target audience (or lookalike audience).

The content provider device 110 may also detect or receive an interaction to initiate the content delivery campaign with the audience definition, according to the definition of the target end-users indicated by the lookalike audience. Upon receipt, the content provider device 110 may provide, send, or transmit an indication to initiate to the placement server 105. The placement server 105 may in turn receive the indication and initiate the content delivery campaign with the target audience defined by the contextual topics of the lookalike audience.

Subsequently, one of the end-user devices 125 may access a webpage hosted on the third-party server 115. The webpage may include an element (e.g., an inline frame) into which the placement server 105 or the third-party server 115 inserts content (e.g., online advertisement) from an entity associated with the content provider device 110.

Upon reading the element, the end-user device 125 may generate a request for a selection value for inserting content into the element of the webpage. The selection value may be used by the content exchange server 120 to select content (e.g., online advertisement) from the content provider device 110 to place on a webpage accessed by the end-user device 125. The request may include an identifier for the end-user device 125, among other information. The identifier for the end-user device 125 may correspond to one of the identifiers in the definition of the special audience, the background audience, and/or the target audience. In some embodiments, the end-user device 125 may send the request to the content exchange server 120, and the content exchange server 120 in turn may forward the request to the placement server 105.

The selection handler 170 executing on the placement server 105 may retrieve, receive, or otherwise identify the request for the selection value from the end-user device 125. The request may be part of a part of a bid stream. The bid stream may be a data stream of published URLs available (e.g., available webpages) for bids to content-users (sometimes referred to as “content generators” or content-generating users”) interested in placing campaign content at those URLs. Upon receipt, the selection handler 170 may parse the request for the selection value to extract or identify the identifier for the end-user device 125. With the identification, the selection handler 170 may compare the identifier with the identifiers in the end-users of the lookalike audience defined for the target audience of the content delivery campaign of the content provider device 110.

In some embodiments, based upon the comparison, the selection handler 170 may determine whether the identifier is part of the lookalike audience for the content delivery campaign of the content provider device 110. If the identifier is not for an end-user (or end-user device 125) of the lookalike audience, the selection handler 170 may refrain from providing the selection value.

In some embodiments, the selection handler 170 may request the content provider device 110 for the selection value, with an indication that the end-user device 125 is not part of the audience. Conversely, if the identifier is part of the audience, the selection handler 170 may retrieve, receive, or identify the selection value for the content provider device 110 associated with the audience. In some embodiments, the selection handler 170 may request the content provider device 110 for the selection value, with an indication that the end-user device 125 is part of the audience. The selection handler 170 may receive the selection value generated by the content provider device 110 for placement of content into the webpage accessed by the end-user device 125. In some embodiments, the selection handler 170 may access the database 175 to fetch, retrieve, or identify the selection value for the content provider device 110. The database 175 may store and maintain the selection value previously received from the content provider device 110. Upon identification, the selection handler 170 may provide, send, or transmit the selection value to the content exchange server 120.

The content exchange server 120 may manage competitions among content provider device 110 to compete for opportunities to deliver content on various webpages, such as the webpage accessed by the end-user device 125. The content exchange server 120 may be any third-party external web-service that publishes information (e.g., API service) and instructions (e.g., API requests) for executing various tasks described herein. Using the content selection values of the content provider devices 110, the content exchange server 120 may run a content selection process (e.g., a real time bid auction) to select one of the content provider devices 110. For example, the content exchange server 120 may select the content provider device 110 with the highest content selection value. The content exchange server 120 may send an indication of the selection to the selected content provider device 110. The content provider device 110 in turn may send, provide, or transmit the content to the element in the webpage accessed by the end-user device 125.

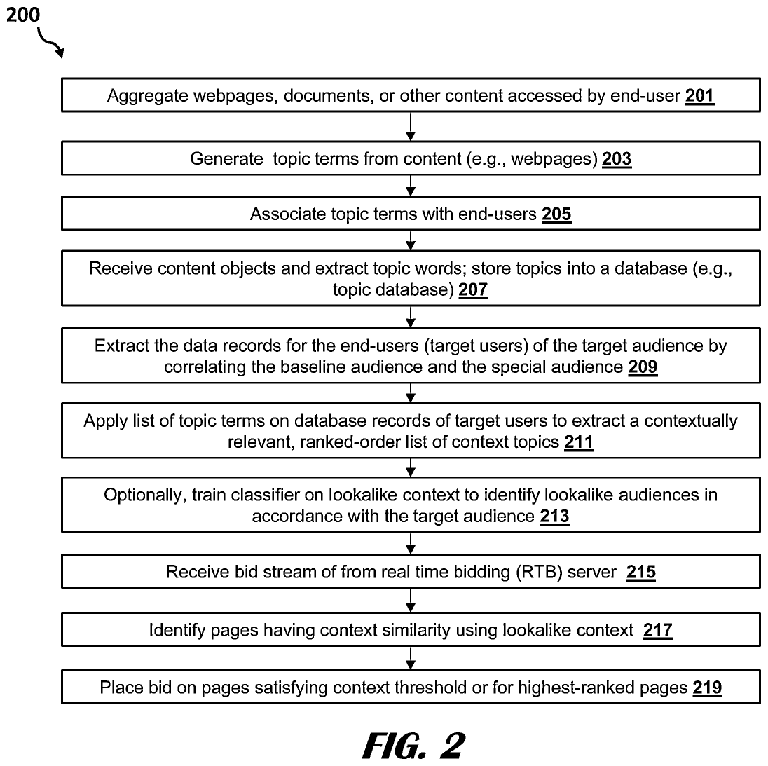

FIG. 2 depicts a flow chart of a method 200 for configuring a target audience of targeted end-users that define a lookalike audience for content delivery, according to an embodiment. For ease of description, a server performs various operations described for the method 200, though in other embodiments, the method 200 or certain aspects of the method 200 may be performed by any number of computing devices and/or by various types of computing devices. In some embodiments, for example, the method 200 may be performed by one or more components described with respect to the system 100 of FIG. 1.

In operation 201, the server aggregates content (e.g., webpages, documents) historically accessed by end-users and, in some cases, various types of end-user data (e.g., end-user device IP address, end-user device MAC address) for end-users having accessed these historic webpages. The server stores the historic webpages and the user data into one or more databases, such as a corpus database, end-user database, or topic database. Each webpage includes an online computing file containing machine-executable code in a markup language hosted on a third-party server. The server may extract various types of data from the webpages, including text, terms, or phrases.

In operation 203, the server identifies and generates topic terms from the webpages in the corpus database. Each topic term defines or identifies a semantic meaning or subject of the content in the webpage. In some cases, the server may apply a natural language processing algorithm to the webpages to derive the topic terms.

In operation 205, the server associates a set of topic terms with the end-users. The server identifies the end-users that accessed the particular webpages from which the server derived the topic term. With the identification, the server may associate the topic term(s) of the webpages with the end-users that accessed the particular webpages, and stores this information into the one or more databases (e.g., end-user database, topic database).

In operation 207, the server receives configuration inputs for developing a contextual campaign. The server receives the configuration inputs from the content-user via a user interface. The configuration inputs indicate, for example, a target audience, baseline audience, and a special audience. The target audience includes the end-users that the content-user would like to identify and target for the proposed contextual campaign. The baseline audience includes a broad population of end-users having a population characteristic (e.g., geography). The special audience includes a selected population of end-users having one or more special characteristics.

The content-user may configure the target audience to include certain desired attributes, such as the size of the target audience, the topic terms of interest (e.g., in-context terms, out-of-context terms), and baseline audience characteristics.

To configure the baseline audience, the content-user enters a configuration input indicating the population characteristic. The population characteristic defines a broad population of end-users. Non-limiting examples of population characteristics include geography, gender, institution (e.g., university students, alumni, and employees; employees of governmental entity), or professional group, among other population markers.

To configure the special audience, the content-user may enter a configuration input for the server to identify the special characteristic. In some cases, the configuration input expressly indicates the special characteristic. In some cases, the configuration input indicates the types of data or types of data inputs that indicate the special characteristic. In some cases, the content-user uploads or forwards, to the server, a dataset of end-users having the special characteristic.

For instance, the server receives end-user information, which may include an upload of a stored or software-generated Customer Relationship Management (CRM) list or pixel (tracking) information indicating the end-users who recently interacted with a content provider webpage. As an example, a bank may upload a CRM list or provide pixel information for bank customers who recently purchased mortgages from the bank. For instance, each time the bank webpage receives a mortgage application, a pixel fires at the bank server, and the server updates the special audience to include the customer as another end-user for the special audience.

As another example, the content-user intends to establish a contextual campaign for a target audience of end-users located in Washington, D.C., and interested in hockey. The content-user configures the baseline audience, as the population of end-users located in Washington, D.C., by entering a configuration input indicating the location. The content-user indicates the special characteristic by, for example, uploading a dataset of end-users who previously purchases hockey gear from the content-provider's website. The content-user may operate devices that capture end-user information associated with end-user phones entering a predefined geo-fence for a defined geographic location (e.g., sports arena). When the end-user's phone enters the geo-fenced location, the content-user's device captures and forwards the end-user's information to the server.

In operation 209, the server extracts the data records for the end-users of the target audience by correlating the baseline audience and the special audience. Continuing with the earlier example, the server identifies the target audience of Washingtonians interested in hockey based on identifying, for example, the end-users located in Washington, D.C., and conducted an online transaction for hockey gear or accessed online content about hockey.

In some cases, the server receives the information needed for correlating the baseline audience and the special audience from the content-user. As an example, the server receives a complete background dataset (e.g., webpage access logs; registered users of website; publicly available database) and a complete special dataset (e.g., transaction database; webpage access logs), which the server correlates. As another example, the server receives a simple background audience characteristic indicator and a complete special dataset, where the server queries or filters the special dataset according to the background audience characteristic.

In some cases, the server receives only certain amounts of information about the special audience. In such cases, the server continues to collect and store data records for the end-users to build the special audience. In some implementations, the server does not proceed with the method 200 until the server collects a threshold number of end-users in the special audience.

In certain circumstances, the background audience dataset is too large or unwieldy. In such circumstances, the server retrieves a sampled subset of a portion of the background audience dataset. As an example, the background audience dataset may include a major sporting goods store that sells equipment for multiple sports and operates one or more stores in a given geography. In this example, rather than instructing the server to query an entire database for a metropolitan area as the background audience, the server may pull the database records for the sample set that represent the end-users for the background audience.

In operation 211, after identifying the end-users of the target audience (or target users), the server applies the stored list of topic terms on the database records of the target users to extract a contextually relevant, ranked-order list of context topics. For each identified target user, the server computes relationship scores between the target user and each of the topic terms. Database records for the particular target user indicate the topics identified in prior content accessed by the target user. After the server generates the scores for each topic term, the server ranks the topic terms to generate the ranked-order list of context topics for the target audience, which the server stores into a database as a lookalike context.

In some implementations, the server identifies one or more additional context terms having a threshold level of co-occurrence with one or more corresponding context topics in the ranked-order list (generated in operations 211). The server updates the ranked-order list of context topics for the target audience to include the additional context terms, which the server stores into the database as an updated version of the lookalike context terms.

For example, server outputs the ranked-order list of lookalike context terms to the user interface of the content-user. The server generates this ranked-order list of lookalike context terms after combining multiple ranked-order lists of topic words according to a word co-occurrence graph. This final ranked-order list includes the output of performing statistical analysis of well-connected or interconnected terms indicating topic terms having relatively high-degrees of interconnectedness in the topic term database. In some cases, the server de-duplicates topic terms in the ranked-order list of lookalike context terms before storing the lookalike context terms into the database.

Optionally, in operation 213, the server trains a classifier of a machine-learning architecture on the lookalike context terms, where the server trains the classifier to identify lookalike audiences corresponding to the target audience configured by the content-user. For instance, the server applies the classifier on the database records of the target users (as determined in operation 209) and performs, for example, a logistic regression function on the target users to train the classifier.

Continuing the hockey example, the server identified 3,000 target users of Washingtonians interested in hockey based on, for example, prior online activity (e.g., website content; e-commerce transaction activity) indicated by the end-users' database records. The server performs logistic regression on the database records for the 3,000 target users. While the logistic regression could consider any number of data types, the logistic regression function is particularly applied on the lookalike context terms, which includes the ranked-order list of context topics for the target audience (as identified in operation 211). Although it is possible in some embodiments, the logistic regression need not train the classifier to predict, for example, whether an end-user will attend a hockey game. The logistic regression trains a classifier to predict which topic terms yield a prediction for the content-user's campaign. In this way, the server may quickly determine whether a new end-user “looks like” the target audience sought by the content-user. When the server receives a new data record for a new end-user, the server applies the classifier on the types of data received with the new data record to classify the new end-user as a member of a lookalike audience.

In some cases, the logistic regression trains the classifier to predict whether a website has a lookalike audience relative to the target audience, where the website contains topic terms indicating that the website's audience would include or be interesting to the target audience. In some cases, the logistic regression trains the classifier to predict whether a new end-user classifies as a lookalike of the target audience based on the topic terms in the new user's data record.

For illustrative purposes, the method system 200 applies the classifier for placing bids for website through a real-time bidding (RTB) service, though embodiments are not so limited. The server may send and/or store the trained classifier for the content-user to reference and apply in any number of later operations in which the content-user identifies potential target users based on the topic terms present in the content accessed by end-users.

In operation 215, the server receives a bid stream from a RTB server of the RTB service. The bid stream indicates, for example, websites available for placing content or advertisements on behalf of the content-user or otherwise indicates or sends an availability list of available webpages. In operation 217, the server identifies websites having the lookalike context topics. As an example, the server may apply the classifier on the topic terms of each website to predict whether the website likely has a lookalike audience to the target audience.

In operation 219, the server places bids on pages satisfying a context threshold or for a predetermined number of highest-ranked pages (most closely classified according to the classifier's outputs). The server may transmit bids to the RTB server, where the server may identify a bid request for a webpage of interest, likely accessed by end-users in the lookalike audience and places a bid at the RTB server.

FIGS. 3A-3E show a user interface 300a-300e for configuring a contextual content campaign directed to a particular target audience by a content-user, according to an embodiment. In this example, the content-user enters configuration inputs to a server of a computing system to configure the contextual campaign to identify those end-users interested in weddings.

The content-user enters user inputs to the server to configure the target audience. The content-user uploads a dataset of end-users, which the server receives as a configuration input of a special audience collected from the end-users who visit wedding blog sites. Additionally, the server receives a configuration input indicating a background (or baseline) audience of all users in the United States.

The server includes software code to extract a ranked-ordered list of topics, based upon various statistics indicating topic terms accessed by the end-users of the special audience and the background audience. The statistics include, for example, “popFracOfUsers” (indicating a fraction of end-users who have the corresponding topic word in a data record of the user) and “popWeight” (indicating that, when the topic word appears, what fraction of the total words the particular topic word makes up), among others. As shown in FIG. 3A, the statistics for the background population have a prefix of “pop,” and statistics for the special audience population do not have that prefix. The server generates, for example, a list of context terms including “bridal,” “wedding reception,” and “wedding dress.”

FIGS. 3B-3D show images of the user interface 300b-300d operated by the content-user for configuring the contextual campaign directed to the target audience of end-users interested in wedding blogs. Each user interface 300b-300d indicates engagement likelihood for lookalike audiences by applying the trained classifier on various groups of end-users or website topic terms (in one or more databases). In FIG. 3E, the user interface 300e displays additional context topic terms that the content-user may include into the previously generated ranked-ordered list of context terms.

Embodiments include a computer-implemented method for determining audiences of contextually relevant content distribution, comprising: receiving, by a computer, one or more configuration inputs via a user interface of a content-user, the one or more configuration inputs indicating a target audience and one or more context terms; identifying, by the computer, a set of target users associated with the one or more context terms defining the target audience, by cross-referencing a first plurality of end-users of a special audience against a second plurality of end-users of a background audience; identifying, by the computer, a ranked-order list of context terms associated with each target end-user of the target audience; and training, by the computer, a classifier to predict a probability of a lookalike audience for a webpage by applying the classifier on the ranked-order list of context terms associated with the target audience.

The method may further comprise applying, by the computer, the classifier on a plurality of topic terms of the webpage to predict a likelihood of the lookalike audience for the webpage.

The method may further comprise generating, by the computer, the special audience based upon user data of each end-user in the first plurality of end-users of the special audience according to the one or more configuration inputs.

The method may further comprise updating, by the computer, the special audience according to additional user data received from one or more client devices.

The method may further comprise selecting, by the computer, the background audience from a database according to a background feature indicated by the one or more configuration inputs.

Selecting the background audience may include extracting, by the computer, a sample subset of user data records from the database for the second plurality of end-users of the background audience.

The method may further comprise determining, by the computer, a plurality of co-occurrence probabilities for a plurality of topic terms in a plurality of corpus webpages.

The method may further comprise, for a particular end-user, identifying, by the computer, one or more historic webpages accessed by the particular end-user; identifying, by the computer, a plurality of topic terms of the one or more historic webpages accessed by the particular end-user; and updated, by the computer, a data record for the particular end-user to include the plurality of topic terms.

The method may further comprise transmitting, by the computer to a client device, instructions for displaying the target audience via the user interface of the client device.

The method may further comprise receiving, by the computer from a bid server, an availability list of a plurality of available webpages requesting bids; and for each available webpage of a bid stream, generating, by the computer, the probability of the lookalike audience for the available webpage by applying the classifier on a plurality of topic terms of the available webpage.

Some embodiments include a system for determining audiences of contextually relevant content distribution. The system may comprise a computer having at least one processor, configured to: receive one or more configuration inputs via a user interface of a content-user, the one or more configuration inputs indicating a target audience and one or more context terms; identify a set of target users associated with the one or more context terms defining the target audience, by cross-referencing a first plurality of end-users of a special audience against a second plurality of end-users of a background audience; identify a ranked-order list of context terms associated with each target end-user of the target audience; and train a classifier to predict a probability of a lookalike audience for a webpage by applying the classifier on the ranked-order list of context terms associated with the target audience.

The computer may be further configured to apply the classifier on a plurality of topic terms of the webpage to predict a likelihood of the lookalike audience for the webpage.

The computer may be further configured to generate the special audience based upon user data of each end-user in the first plurality of end-users of the special audience according to the one or more configuration inputs.

The computer may be further configured to update the special audience according to additional user data received from one or more client devices.

The computer may be further configured to select the background audience from a database according to a background feature indicated by the one or more configuration inputs.

When selecting the background audience, the computer may be further configured to extract a sample subset of user data records from the database for the second plurality of end-users of the background audience.

The computer may be further configured to determine a plurality of co-occurrence probabilities for a plurality of topic terms in a plurality of corpus webpages.

The computer may be further configured to: for a particular end-user, identify one or more historic webpages accessed by the particular end-user; identify a plurality of topic terms of the one or more historic webpages accessed by the particular end-user; and update a data record for the particular end-user to include the plurality of topic terms.

The computer may be further configured to transmit, to a client device, instructions for displaying the target audience via the user interface of the client device.

The computer may be further configured to: receive, from a bid server, an availability list of a plurality of available webpages requesting bids; and for each available webpage of a bid stream, generate, by the computer, the probability of the lookalike audience for the available webpage by applying the classifier on a plurality of topic terms of the available webpage.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc., may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for determining audiences of contextually relevant content distribution, comprising:
receiving, by a computer, one or more configuration inputs via a user interface of a content-user, the one or more configuration inputs indicating a target audience and one or more context terms;
identifying, by the computer, a set of target users associated with the one or more context terms defining the target audience, by cross-referencing a first plurality of end-users of a special audience against a second plurality of end-users of a background audience;
identifying, by the computer, a ranked-order list of context terms associated with each target end-user of the target audience; and
training, by the computer, a classifier to predict a probability of a lookalike audience for a webpage by applying the classifier on the ranked-order list of context terms associated with the target audience.

2. The method according to claim 1, further comprising applying, by the computer, the classifier on a plurality of topic terms of the webpage to predict a likelihood of the lookalike audience for the webpage.

3. The method according to claim 1, further comprising generating, by the computer, the special audience based upon user data of each end-user in the first plurality of end-users of the special audience according to the one or more configuration inputs.

4. The method according to claim 3, further comprising updating, by the computer, the special audience according to additional user data received from one or more client devices.

5. The method according to claim 1, further comprising selecting, by the computer, the background audience from a database according to a background feature indicated by the one or more configuration inputs.

6. The method according to claim 5, wherein selecting the background audience includes, extracting, by the computer, a sample subset of user data records from the database for the second plurality of end-users of the background audience.

7. The method according to claim 1, further comprising determining, by the computer, a plurality of co-occurrence probabilities for a plurality of topic terms in a plurality of corpus webpages.

8. The method according to claim 1, further comprising:
for a particular end-user, identifying, by the computer, one or more historic webpages accessed by the particular end-user;
identifying, by the computer, a plurality of topic terms of the one or more historic webpages accessed by the particular end-user; and
updated, by the computer, a data record for the particular end-user to include the plurality of topic terms.

9. The method according to claim 1, further comprising transmitting, by the computer to a client device, instructions for displaying the target audience via the user interface of the client device.

10. The method according to claim 1, further comprising:
receiving, by the computer from a bid server, an availability list of a plurality of available webpages requesting bids; and
for each available webpage of a bid stream, generating, by the computer, the probability of the lookalike audience for the available webpage by applying the classifier on a plurality of topic terms of the available webpage.

11. A system for determining audiences of contextually relevant content distribution, comprising:
a computer having at least one processor, configured to:
receive one or more configuration inputs via a user interface of a content-user, the one or more configuration inputs indicating a target audience and one or more context terms;
identify a set of target users associated with the one or more context terms defining the target audience, by cross-referencing a first plurality of end-users of a special audience against a second plurality of end-users of a background audience;
identify a ranked-order list of context terms associated with each target end-user of the target audience; and
train a classifier to predict a probability of a lookalike audience for a webpage by applying the classifier on the ranked-order list of context terms associated with the target audience.

12. The system according to claim 11, wherein the computer is further configured to apply the classifier on a plurality of topic terms of the webpage to predict a likelihood of the lookalike audience for the webpage.

13. The system according to claim 11, wherein the computer is further configured to generate the special audience based upon user data of each end-user in the first plurality of end-users of the special audience according to the one or more configuration inputs.

14. The system according to claim 13, wherein the computer is further configured to update the special audience according to additional user data received from one or more client devices.

15. The system according to claim 11, wherein the computer is further configured to select the background audience from a database according to a background feature indicated by the one or more configuration inputs.

16. The system according to claim 15, wherein when selecting the background audience, the computer is further configured to extract a sample subset of user data records from the database for the second plurality of end-users of the background audience.

17. The system according to claim 11, wherein the computer is further configured to determine a plurality of co-occurrence probabilities for a plurality of topic terms in a plurality of corpus webpages.

18. The system according to claim 11, wherein the computer is further configured to:
for a particular end-user, identify one or more historic webpages accessed by the particular end-user;
identify a plurality of topic terms of the one or more historic webpages accessed by the particular end-user; and
update a data record for the particular end-user to include the plurality of topic terms.

19. The system according to claim 11, wherein the computer is further configured to transmit, to a client device, instructions for displaying the target audience via the user interface of the client device.

20. The system according to claim 11, wherein the computer is further configured to:
receive, from a bid server, an availability list of a plurality of available webpages requesting bids; and
for each available webpage of a bid stream, generate, by the computer, the probability of the lookalike audience for the available webpage by applying the classifier on a plurality of topic terms of the available webpage.
